(19) United States
(12) Patent Application Publication
(10) Pub. No.: US 2009/0035653 A1
(43) Pub. Date: Feb. 5, 2009

(54) MULTIPLE-PAIR-TERMINAL BATTERY RECEPTACLE

(76) Inventor: Wen-Chin Shiau, Tao-Yuan Hsien (TW)

Correspondence Address: BUTZEL LONG;IP DOCKETING DEPT, 350 SOUTH MAIN STREET, SUITE 300, ANN ARBOR, MI, 48104, US

(21) Appl. No.: 12/051,382

(22) Filed: Mar. 19, 2008

(30) Foreign Application Priority Data
Aug. 2, 2007 (TW) 096212694

(51) Int. Cl. H01M 2/00

(52) U.S. Cl. 429/179

(57) ABSTRACT

A multiple-pair-terminal battery receptacle includes a casing, first and second anode terminals, first and second conductive members, and first and second cathode terminals. The first anode terminal is mounted on the casing. The first conductive member is disposed in the casing and is coupled to the first anode terminal. The second anode terminal is mounted removably on the casing and engages detachably the second end portion of the first conductive member. Each of the first and second cathode terminals is mounted on the casing. The second conductive member interconnects the first and second cathode terminals.

### CROSS-REFERENCE TO RELATED APPLICATION

This application claims priority of Taiwanese application no. 096212694, filed on Aug. 2, 2007.

### BACKGROUND OF THE INVENTION

1. Field of the Invention

The invention relates to a battery receptacle, more particularly to a battery receptacle that has multiple pairs of anode and cathode terminals.

2. Description of the Related Art

In co-pending U.S. patent application Ser. No. 11/786,209, there is disclosed a multiple-pair-terminal battery receptacle that includes a casing, first and second anode terminals, first and second conductive members, and first and second cathode terminals. The casing includes opposite first and second walls. The first anode terminal is mounted on the first wall of the casing. The first conductive member is disposed in the casing, and has a first end portion that extends through the first wall of the casing and that is coupled to the first anode terminal, and a second end portion that is opposite to the first end portion thereof, that extends through the second wall of the casing, and that serves as the second anode terminal. Each of the first and second cathode terminals is mounted on a respective one of the first and second walls of the casing. The second conductive member interconnects the first and second cathode terminals.

The aforementioned multiple-pair-terminal battery receptacle of the co-pending U.S. patent application Ser. No. 11/786,209 is disadvantageous in that the first conductive member is manufactured such that a length thereof permits the second end portion thereof, which serves as the second anode terminal, to barely extend through the second wall of the casing. As such, when the length of the first conductive member is shortened due to wear, a reliable contact between the second anode terminal of this multiple-pair-terminal battery receptacle and an anode terminal of another battery charger or an electronic device can not be ensured.

### SUMMARY OF THE INVENTION

Therefore, the object of the present invention is to provide a multiple-pair-terminal battery receptacle that can overcome the aforesaid drawback of the prior art.

According to the present invention, a multiple-pair-terminal battery receptacle comprises a casing, first and second anode terminals, first and second conductive members, and first and second cathode terminals. The first anode terminal is mounted on the casing. The first conductive member is disposed in the casing, and has a first end portion coupled to the first anode terminal, and a second end portion opposite to the first end portion thereof. The second anode terminal is mounted removably on the casing, and engages detachably the second end portion of the first conductive member. Each of the first and second cathode terminals is mounted on the casing. The second conductive member interconnects the first and second cathode terminals.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic sectional view of the first preferred embodiment of a multiple-pair-terminal battery receptacle according to the present invention;

FIG. 2 is a perspective view of an anode terminal of the first preferred embodiment;

FIG. 3 is a schematic sectional view to illustrate an exemplary application in which the anode terminal of the first preferred embodiment contacts an anode terminal of another battery receptacle;

FIG. 4 is a schematic sectional view to illustrate an exemplary application in which the anode terminal of the first preferred embodiment contacts an anode terminal of an electronic device; and

FIG. 5 is a perspective view of an anode terminal according to the second preferred embodiment of the multiple-pair-terminal battery receptacle of this invention.

### DETAILED DESCRIPTION OF THE PREFERRED EMBODIMENTS

Before the present invention is described in greater detail, it should be noted that like elements are denoted by the same reference numerals throughout the disclosure.

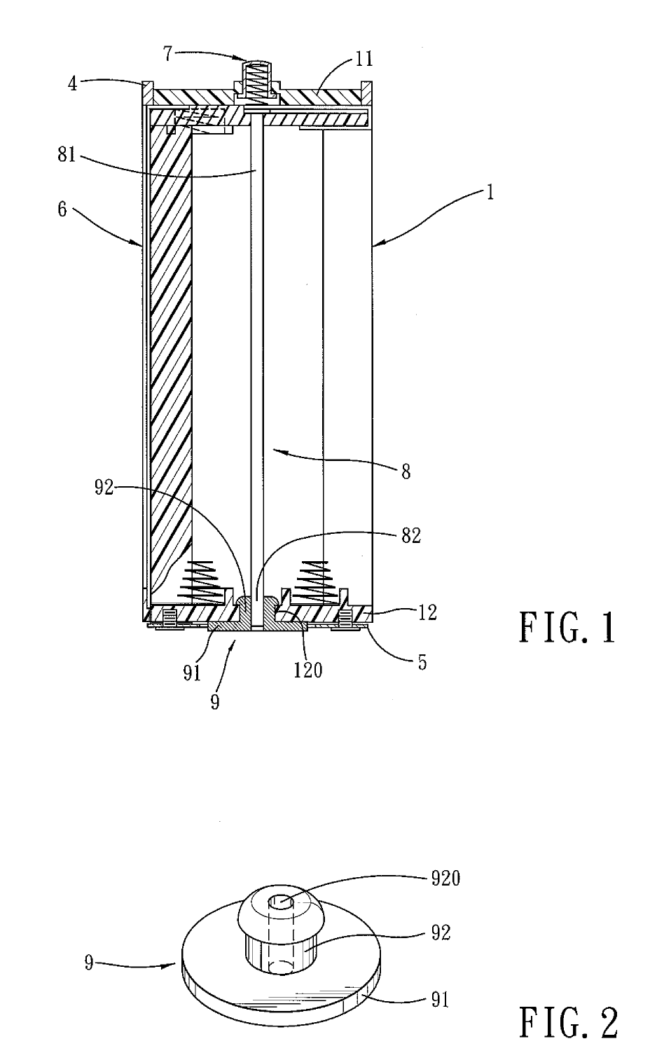

Referring to FIG. 1, the first preferred embodiment of a multiple-pair-terminal battery receptacle according this invention is shown to include a casing 1, first and second anode terminals 7, 9, first and second conductive members 8, 6, and first and second cathode terminals 4, 5.

The casing 1 includes a first wall 11, and a second wall 12 that is opposite to the first wall 12 thereof and that is formed with a hole 120 therethough.

The first anode terminal 7 is mounted on the first wall 11 of the casing 1.

The first conductive member 8 is disposed in the casing 1, and has a first end portion 81 that extends through the first wall 11 of the casing 1 and that is coupled to the first anode terminal 7, and a second end portion 82 that is opposite to the first end portion 81 thereof. In this embodiment, the first conductive member 8 is in the form of a rod.

The second anode terminal 9 is mounted on the second wall 12 of the casing 1 and engages detachably the second end portion 82 of the first conductive member 8. In particular, with further reference to FIG. 2, the second anode terminal 9 has first and second end portions 91, 92. The first end portion 91 of the second anode terminal 9 is disposed externally of the casing 1 and has a size larger than that of the hole 120 in the second wall 12 of the casing 1. In this embodiment, the first end portion 91 of the second anode terminal 9 has a circular shape. The second end portion 92 of the second anode terminal 9 extends from the first end portion 91 of the second anode terminal 9 into the casing 1 through the hole 120 in the second wall 12 of the casing 1, is formed with an engaging groove 920 therein, and is sleeved on the second end portion 82 of the first conductive member 8 such that the second end portion 82 of the first conductive member 8 is received snugly in the engaging groove 920 in the second end portion 92 of the second anode terminal 9. In this embodiment, the second end portion 92 of the second anode terminal 9 has a substantially cylindrical shape.

Each of the first and second cathode terminals 4, 5 is mounted on a respective one of the first and second walls 11, 12 of the casing 1.

The second conductive member 6 interconnects the first and second cathode terminals 4, 5.

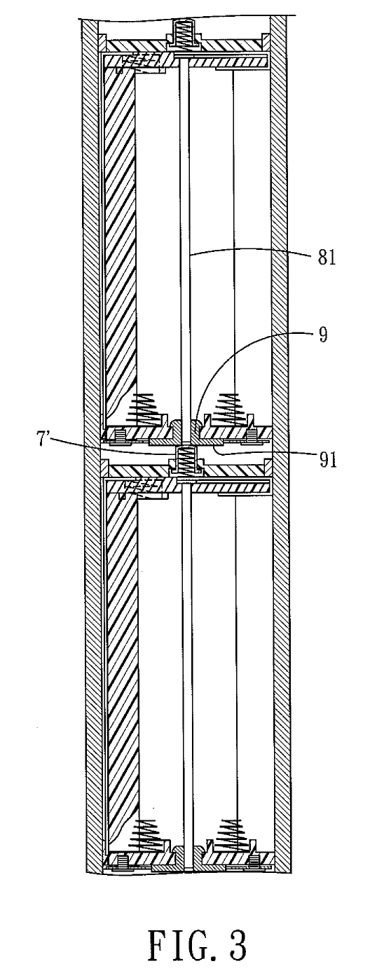

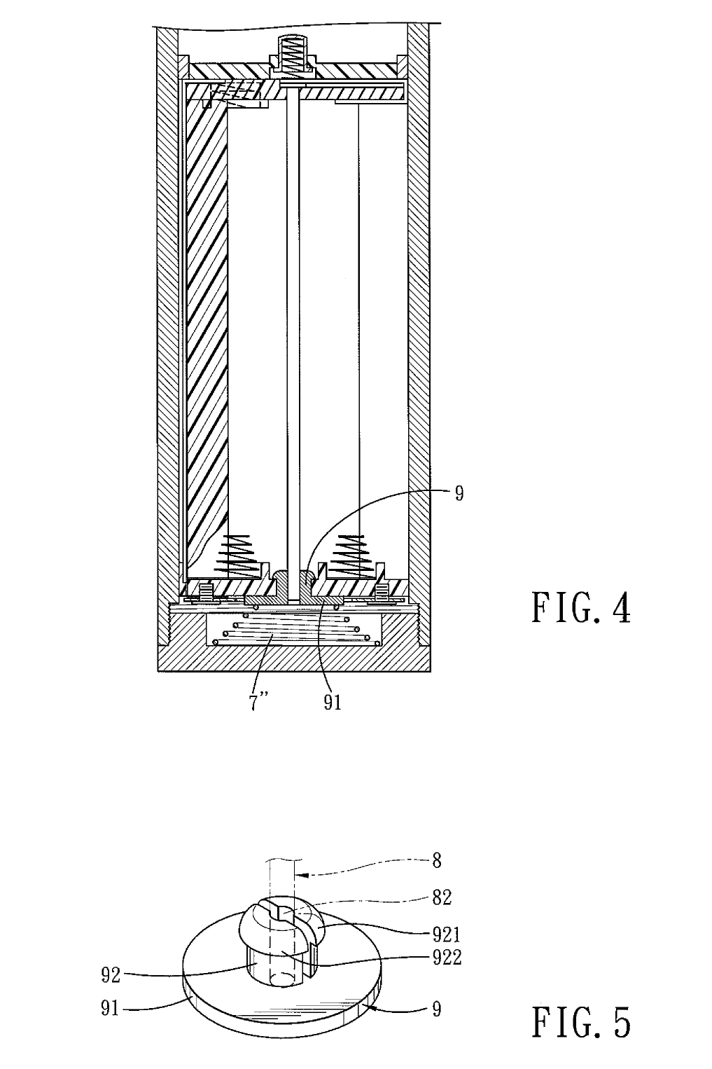

The first end portion 91 of the second anode terminal 9 may contact an anode terminal 7′ of another battery receptacle, as illustrated in FIG. 3, or an anode terminal 7″, which is in the form of a spiral spring, of an electronic device, such as a flashlight, as illustrated in FIG. 4.

It is noted that the construction of the second anode terminal 9 of the multiple-pair-terminal battery receptacle of this invention as such ensures a reliable contact to an anode terminal of another battery receptacle or an electronic device.

FIG. 5 illustrates the second preferred embodiment of a multiple-pair-terminal battery receptacle according to this invention. When compared to the previous embodiment, the second end portion 92 of the second anode terminal 9 includes a pair of clamping arms 921, 922. The second end portion 82 of the first conductive member 8 is clamped between the clamping arms 921, 922 of the second end portion 92 of the second anode terminal 9.

It is noted that the hole 120 in the second wall 12 of the casing 1 is defined by a hole-defining wall, and the second end portion 92 of the second anode terminal 9 is in snap engagement with the hole-defining wall.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A multiple-pair-terminal battery receptacle, comprising:
a casing;
a first anode terminal mounted on said casing;
a first conductive member disposed in said casing, and having a first end portion coupled to said first anode terminal, and a second end portion opposite to said first end portion thereof;
a second anode terminal mounted removably on said casing, and engaging detachably said second end portion of said first conductive member;
first and second cathode terminals, each of which is mounted on said casing; and
a second conductive member interconnecting said first and second cathode terminals.

2. The multiple-pair-terminal battery receptacle as claimed in claim 1, wherein said second anode terminal has a first end portion that is disposed externally of said casing, and a second end portion that extends from said first end portion thereof into said casing and that engages detachably said second end portion of said first conductive member.

3. The multiple-pair-terminal battery receptacle as claimed in claim 2, wherein said second end portion of said second anode terminal is formed with an engaging groove therein, and said second end portion of said first conductive member is received snugly in said engaging groove in said second end portion of said second anode terminal.

4. The multiple-pair-terminal battery receptacle as claimed in claim 2, wherein said casing is formed with a hole therethrough for extension of said second end portion of said second anode terminal, said first end portion of said second anode terminal having a size larger than that of said hole in said casing.

5. The multiple-pair-terminal battery receptacle as claimed in claim 2, wherein said second end portion of said second anode terminal includes a pair of clamping arms for clamping said second end portion of said first conductive member therebetween.

6. The multiple-pair-terminal battery receptacle as claimed in claim 1, wherein said first conductive member is in the form of a rod.
